(19) United States
(12) Patent Application Publication
(10) Pub. No.: US 2022/0284726 A1
(43) Pub. Date: Sep. 8, 2022

(54) OPTICAL MODULE AND AUTHENTICATION DEVICE

(71) Applicant: SONY GROUP CORPORATION, Tokyo (JP)

(72) Inventor: Shoji TAKEI, Tokyo (JP)

(73) Assignee: SONY GROUP CORPORATION, Tokyo (JP)

(21) Appl. No.: 17/636,603

(22) PCT Filed: Jul. 16, 2020
(86) PCT No.: PCT/JP2020/027668

§ 371 Date: Feb. 18, 2022

(30) Foreign Application Priority Data
Sep. 25, 2019 (JP) 2019-173891

(51) Int. Cl. G06V 40/13; G02B 3/00; G02B 13/18; F21V 8/00; G06V 10/147; G06K 7/14; G06K 7/10

(52) U.S. Cl. CPC G06V 40/1318; G02B 3/0056; G02B 13/18; G02B 6/0036; G02B 3/0075; G06V 10/147; G06K 7/1417; G06K 7/10722; G02B 5/005

(57) ABSTRACT

An optical module includes: a first lens having a first principal surface and a second principal surface; and a second lens having a third principal surface and a fourth principal surface, the first principal surface is configured by a flat surface, and on the second principal surface, a concave lens array having a plurality of concave lenses is formed, and on each of the third principal surface and the fourth principal surface, a convex lens array having a plurality of convex lenses is formed, and the second principal surface and the third principal surface are arranged in such a way as to face each other.

### TECHNICAL FIELD

The present disclosure relates to an optical module and an authentication device.

### BACKGROUND ART

There have been known devices, each of which authenticates a part of a living body (for example, a fingerprint) (for example, the below-mentioned Patent Documents 1 and 2).

### CITATION LIST

### Patent Document

Patent Document 1: Japanese Patent Application Laid-Open No. 2005-261793

### SUMMARY OF THE INVENTION

### Problems to be Solved by the Invention

In such a field, it is desired to downsize the devices.

One of objects of the present disclosure is to provide an optical module and as authentication device, each of which has a structure allowing a device, which authenticates, for example, a part of a living body, to be downsized.

### Solutions to Problems

The present disclosure is, for example, an optical module including:

a first lens having a first principal surface and a second principal surface; and

a second lens having a third principal surface and a fourth principal surface,

the first principal surface is configured by a flat surface and on the second principal surface, a concave lens array having a plurality of concave lenses is formed,

on each of the third principal surface and the fourth principal surface, a convex lens array having a plurality of convex lenses is formed, and

the second principal surface and the third principal surface are arranged in such a way as to face each other.

In addition, the present disclosure may be an authentication device which includes the above-described optical module.

### BRIEF DESCRIPTION OF DRAWINGS

FIG. 1 is a diagram referenced when an external appearance example of a wristband type electronic device according to one embodiment is explained.

FIG. 2 is a block diagram showing a circuit configuration example of the wristband type electronic device according to the one embodiment.

FIG. 3 is a view illustrating an optical module according to one embodiment, viewed from a side surface.

FIG. 4 is a view illustrating the optical module according to the one embodiment, viewed from a top surface.

FIG. 5 is a diagram referenced when a setting example of a reflecting surface angle according to the one embodiment is explained.

FIG. 6 is a diagram referenced when the setting example of the reflecting surface angle according to the one embodiment is explained.

FIG. 7 is a diagram referenced when a usage example of the optical module according to the one embodiment is explained.

FIG. 8 is a diagram referenced when modified examples are explained.

FIG. 9 is a diagram referenced when a modified example is explained.

### MODE FOR CARRYING OUT THE INVENTION

Hereinafter, with reference to the accompanying drawings, embodiments and the like of the present disclosure will be described. Note that the description will be given in the following order.
<One Embodiment>
<Embodiments>
<Modified Examples>

The below-described embodiments and The like are preferred specific examples of the present disclosure and contents of the present disclosure are not limited to these embodiments and the like.

Note that it is not intended that description relating to dimensions, materials, shapes of constituting members, relative locations thereof, directions such as a vertical direction and a horizontal direction are limited to those described in the embodiments and the like unless otherwise limited and the description relating thereto is merely illustrative. Note that there may be a case where sizes of members, positional relationship thereof, and the like illustrated in the drawings are exaggerated in order to clarify the description and there may also be a case where only one part of reference signs is shown in the drawings or a case where illustration is simplified in order to prevent the illustration from being complicated. Furthermore, in the description given below, the same names and the same reference signs denote the same members or members having the same materials, and overlapping description therefor will be appropriately omitted. Furthermore, in a configuration of components in the present disclosure, each of a plurality of components may be the same one member or one member shares the plurality of components, or conversely, a function of one member may also be shared by a plurality of members.

In the present embodiment, the description is given with an authentication device taken as an example, and the authentication device images a fingerprint as one example of a part of a living body and performs authentication by using a fingerprint image obtained by imaging. Specifically, in the present embodiment, the description is given with a wearable device taken as an example, and the wearable device as the authentication device is a device which is attachable and detachable to and from a human body and is comparatively small-sized. Further specifically, the description is given with a wearable device, which is a wristband type (a wristwatch type) (hereinafter, appropriately referred to as a wristband type electronic device), taken as an example. Of course, the electronic device of the present disclosure is not limited to the wearable device. The electronic device of the present disclosure may be a device incorporated into a personal computer or a smartphone. In addition, an imaged target is not limited to the fingerprint and may be a sweat gland, a vein, or the like, and the imaged target is not limited to the part of the living body and may be a code pattern, such as a QR (Quick Response) code (registered trademark) for settlement, which has fixed regularity.

### ONE EMBODIMENT

### As to Wristband Type Electronic Device

### External Appearance Example of Wristband Type Electronic Device

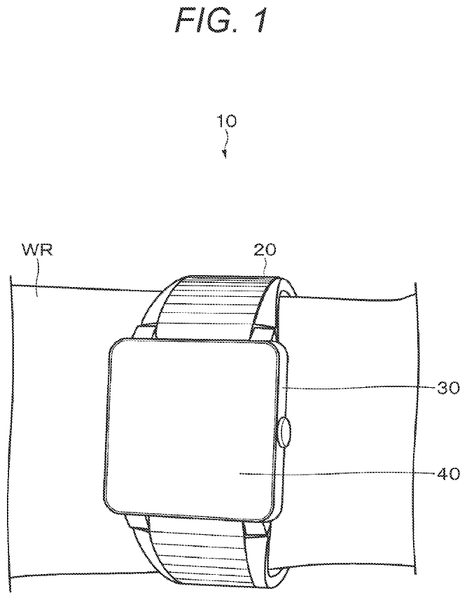

FIG. 1 is a diagram for explaining an external appearance example of a wristband type electronic device (hereinafter, appropriately referred to as a wristband type electronic device 10; according to one embodiment. The wristband type electronic device 10 has a band part 20 which is wound on a wrist WR of a user and a main body part 30. The main body part 30 has a display 40.

A constituent body (material) constituting the band part 20 may be metal such as aluminum and stainless (or may be a material obtained by subjecting the metal to surface treatment such as application of gold-plating) or may be hide, wood, a mineral (stone), fiber (fabric), bamboo, a ceramic, a combination of any thereof, or the like. A constituent body constituting the band part 20 may be a light transmissive member or may be a light non-transmissive member.

The display 40 is constituted of a liquid crystal display (LCD) or organic light emitting diodes (OLEDs). The constituent body itself constituting the band part 20 may be configured so as to function as the display.

For example, in the display 40, a contact region where a fingertip is caused to contact is set. A user brings his or her fingertip into contact with the contact region, thereby imaging a fingerprint of the fingertip and making it possible to perform authentication of the living body, which uses the fingerprint image, or the like. Note that on a side surface of the main body part 30, a contact region may be provided. An image of the fingerprint is captured by using an optical module built in the main body part 30. Details of the optical module will be described later.

### Circuit Configuration Example of Wristband Type Electronic Device

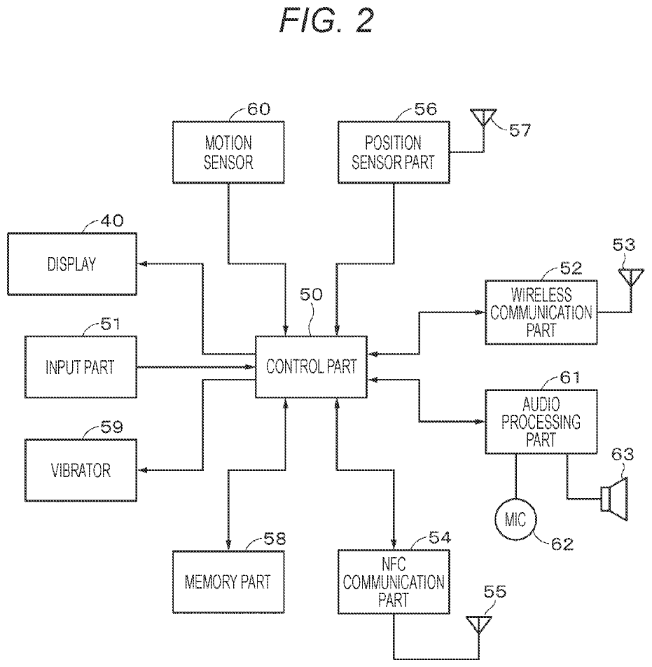

FIG. 2 is a block diagram showing a circuit configuration example of the wristband type electronic device 10 according to one embodiment. Besides the above-described display 40, the wristband type electronic device 10 has, for example, a control part 50, an input part 51, a wireless communication part 52, an antenna 53 which is connected to the wireless communication part 52, a near field communication (NBC) communication part 54, an antenna 55 which is connected to the NBC communication part 54, a position sensor part 56, an antenna 57 which is connected to the position sensor part 56, a memory part 58, a vibrator 59, a motion sensor 60, an audio processing part 61, a microphone 62, and a speaker 63.

The control part 50 is constituted of, for example, a central processing unit (CPU) and comprehensively controls the parts of the wristband type electronic device 10. In addition, the control part 50 performs the heretofore known authentication processing for fingerprint authentication.

The input part 51 is a collective term of a configuration which the wristband type electronic device 10 has in order to accept operation input. As the input part 51, a touch panel, buttons, a dial, or the like is cited. Note that the input part 51 may be a configuration in which audio input for audio recognition is accepted (for example, the speaker 63).

The wireless communication part 52 performs short-range wireless communication with other terminal on the basis or standards of, for example, Bluetooth (registered trademark). The wireless communication part 52 performs modulation/demodulation processing, error correction processing, and the like, dealing with, for example, the standards of Bluetooth (registered trademark).

The NFC communication part 54 performs wireless communication with a reader/writer in proximity thereto on the basis of standards of NFC. Note that although illustration is omitted, electrical power is supplied from a battery such as a lithium-ion secondary battery to the respective parts of the wristband type electronic device 10. The battery may be wirelessly charged on the basis or the standards of NFC.

The position sensor part 56 is a positioning part of a current position by using a system referred to as a global navigation satellite system (GNSS). Data obtained by the wireless communication unit 52, the NFC communication unit 54, and the position sensor unit 56 is supplied to the control unit 50. Then, the control part 50 executes control based on the supplied data.

The memory part 58 is a collective term of a read only memory (ROM) in which a program executed by the control part 50 is stored, a random access memory (RAM) used as a work memory when the control part 50 executes the program, a non-volatile memory for storing data, and the like.

The vibrator 59 is, for example, a member which vibrates the whole wristband type electronic device 10. Notification of incoming of a telephone call, reception of an e-mail, and the like are provided by vibration of the vibrator 59.

The motion sensor 60 detects motion of a user who has worn the wristband type electronic device 10. As the motion sensor 60, an acceleration sensor, a gyroscope sensor, an electronic compass, an atmospheric pressure sensor, or the like is used. Note that the wristband type electronic device 10 may include a sensor other than the motion sensor 60. For example, a biosensor, which detects living body information, other than the fingerprint, such as a blood pressure, a pulse, a sweat gland (which may be a position of the sweat gland or a degree of perspiration from the sweat gland) of a user which has worn the wristband type electronic device 10, may be built therein. In addition, a pressure sensor, for detecting whether or not the user has worn the wristband type electronic device 10, or the like may be provided on a back side of the band part 20.

Connected to the audio processing part 61 are the microphone 62 and the speaker 63, and the audio processing part 61 performs processing of a telephone call with a counterpart who is connected in the wireless communication by the wireless communication part 52. In addition, the audio processing part 61 can also perform processing for audio input operation.

### Configuration Example of Optical Module

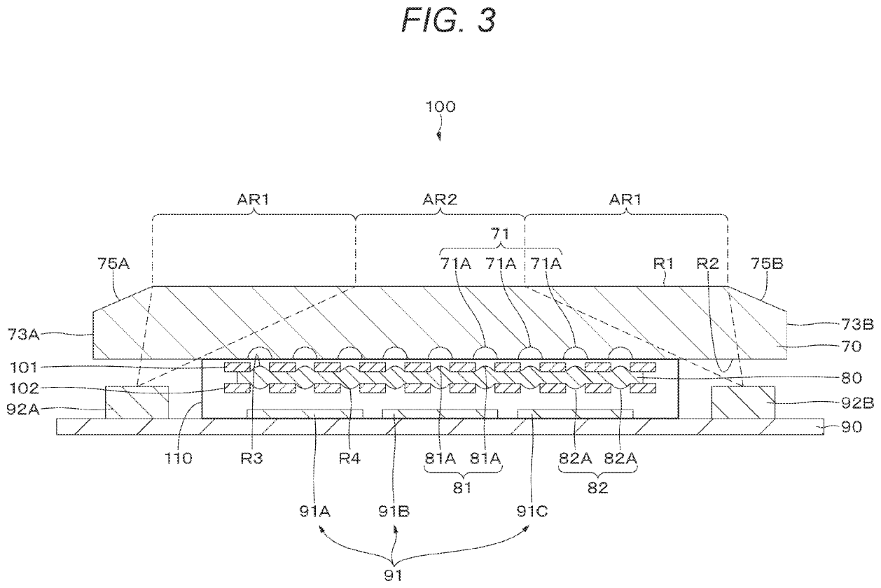

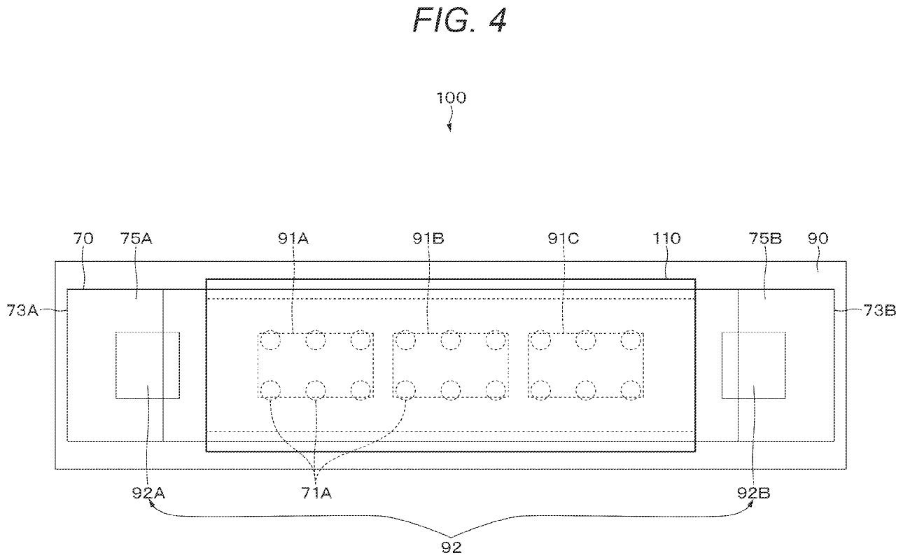

Subsequently, with reference to FIGS. 3 and 4, an optical module (hereinafter, appropriately referred to as an optical module 100) according to the present embodiment will be described in detail FIG. 3 is a side view of the optical module 100 and FIG. 4 is a top view of the optical module 100.

The optical module 100 has a lens 70 as a first lens, a lens 80 as a second lens, an image element 91 mounted on a substrate 90, a light source part 92 (92A and 92B) mounted on the substrate 90, a light shielding body 101 as a first light shielding body, a light shielding body 102 as a second light shielding body, and a frame 110.

The lens 70 schematically has a platy shape having a shorter side direction and a longer side direction in a top view (see FIG. 4). In addition, the lens 70 has an R1 surface as a first principal surface and an R2 surface as a second principal surface on a sole opposite to a side of the first principal surface. In the present embodiment, a size of the R2 surface is set to be larger than a size of the R1 surface. The R1 surface has a flat shape. Note that the flat surface is not limited to a strict flat surface having no irregularities at all and even when irregularities which can be inevitably caused when the lens 70 is manufactured or at other time are present on the R1 surface, such a surface having those irregularities is included as the flat surface in the present disclosure.

All or a part of the R1 surface is set as a contact region of the fingerprint. On the R2 surface, a concave lens array 71 is formed. The concave lens array 71 has a plurality of concave lenses 71A. For example, the concave lens array 71 has the concave lenses 71A, a number of which is 18, with two concave lenses in the shorter side direction and nine concave lenses in the longer side direction. In a case where a focal distance of each of the concave lenses 71A is defined as f1, preferably, a focal distance f1 is set to −0.3<f1<−0.2.

From both ends of the R2 surface in the shorter side direction, wall parts 73A and 73B are provided in a standing manner in a perpendicular direction, the perpendicular direction and the R2 surface forming an angle of substantially 90°. From one end portion of the R1 surface to the wall part 73A, a shoulder surface part 75A (inclined surface) which inclines downward in FIG. 3 is formed. In addition, from the other end portion of the R1 surface to the wall part 73B, a shoulder surface part 75B (inclined surface) which inclines downward in FIG. 3 is formed. As described above, in one portion which connects the R1 surface and the R2 surface, the wall part 73A and the shoulder surface part 75A are continuously formed. In addition, in the other portion which connects the R1 surface and the R2 surface, the wall part 73B and the shoulder surface part 75B are continuously formed.

The shoulder surface parts 75A and 75B are formed so as to cause illumination light emitted from the light source part 92 not to enter the concave lens array 71. In a case where an angle formed between the wall part 73A and the shoulder surface part 75A is defined as a reflecting surface angle θd, a reflecting surface angle θd is set so as to cause the illumination light emitted from the light source part 92 not to enter the concave lens array 71.

The lens 80 has a platy shape having a shorter side direction and a longer side direction in a top view (see FIG. 4). In addition, the lens 80 faces the R2 surface and has an R3 surface as a third principal surface and an R4 surface as a fourth principal surface on a side opposite to a side of the third principal surface. On the R3 surface, a convex lens array 81 is formed. The convex lens array 81 has a plurality of convex lenses 81A. In addition, on the R4 surface, a convex lens array 82 is formed. The convex lens array 82 has a plurality of convex lenses 82A. A number of the convex lenses 81A and a number of the convex lenses 82A are set in a manner similar to a manner in which the number of the concave lenses 71A is set, and in the present embodiment, each of the number of the convex lenses 81A and the number of the convex lenses 82A is set to 18. The concave lenses 71A, the convex lenses 81A, and the convex lenses 82A are positioned on substantially the same axes. In a case where a focal distance of each of the convex lenses 81A and the convex lenses 82A is defined as f2, preferably, a focal distance f2 is set to 0.1<f2<0.35.

Note that a lens having a plurality of single lenses (one lens or a plurality of lenses) is also referred to as a micro lens array (MLA).

The image element 91 is a sensor for imaging the living body or the like which is brought into contact with the R1 surface. As a specific example of the image element 91, a complementary metal oxide semiconductor (CMOS) sensor can be cited.

The image element 91 is mounted on the substrate 90 in such a way as to face the R4 surface. In the present embodiment, the image element 91 has three image elements (image elements 91A, 91B, and 91C) arrayed and mounted on the substrate 90. The three image elements 91A, 91B, and 91C acquire images of the fingerprint contacting the R1 surface in predetermined regions which are different from one another. As described above, even in a case where the plurality of image elements respectively images the partial regions of the fingerprint which are different from one another, it is made possible to perform person authentication which uses the fingerprint by using image information obtained by the above-mentioned imaging and by an authentication technology using machine learning with respect to previously registered fingerprint information. Note that the image element 91 may be a single image element.

The light source part 92 has, for example, two light emitting diodes (LEDs) 92A and 92B. The LEDs 92A and 92B are mounted on, for example, the same surface of the substrate 90 as the surface on which the image element 90 is mounted and are mounted in positions facing both end portion vicinities of the lens 70 in the longer side direction on the substrate 90. A part of light (illumination light) emitted from the light source part 92 travels via the lens 70 and directly reaches the RI surface, In addition, while the part of the light (illumination light) emitted from the light source part 92 is being reflected inside the lens 70, that is, is being guided by the lens 70, the part thereof reaches the R1 surface. As described above, in the R1 surface, regions AR1 which the light from the light source part 92 directly reaches and a region AR2 which the light does not directly reach and light of the light emitted from the light source part 92, which is totally reflected inside the lens 70 (total reflection light) reaches are present.

On a side of the R3 surface of the lens 80, the light shielding body 101 is provided. In addition, on a side of the R4 surface of the lens 80, the light shielding body 102 is provided. The light shielding bodies 101 and 102 are configured, for example, to be filmy. Each of the light shielding bodies 101 and 102 has, for example, a grid-like shape having openings, and the openings of the light shielding body 101 and the openings of the light shielding body 102 are positioned such that positions of the opening of the light shielding body 101 and posit ions of the opening of the light shielding body 102 substantially match each other. The light shielding body 101 has, for example, 18 openings, and in positions of the openings, the convex lenses 81A are located. The light shielding body 101 located in a space among the convex lenses 81A functions as an aperture diaphragm. In addition, the light shielding body 102 has, for example, 18 openings, and in positions of the openings, the convex lenses 821 are located. The light shielding body 102 located in a space among the convex lenses 82A functions to prevent image overlapping of lens groups due to variation in manufacturing and the like and to cut stray light.

The frame 110 is provided on the above-described substrate 90. The frame 110 has, for example, a box-like shape and houses the above-described lens 80, image element 91, light shielding body 101, and light shielding body 102 thereinside. The lens 80, the light shielding body 101, and the light shielding body 102 are supported by the frame 110 by employing an appropriate method (engagement, adhesion, or the like). Outside the frame 110, the above-described LEDs 921 and 92B are located. A top surface of the frame 110 is configured by light-transmissive resin or the like, and the top surface of the frame 110 and the R2 surface of the lens 70 are bonded by, for example, a transparent adhesive. In addition, side surfaces of the frame 110 have undergone processing such as blacking so as to cause light emitted from the LEDs 92A and 92B not to be incident thereon. Between the frame 110 and the LEDs 92A and 92B, a light shielding body may be provided. The components described hereinbefore are integrally fixed so as not to cause positional deviation between the single lenses or the like.

### Setting Example of Reflecting Surface Angle

Incidentally, illumination light emitted from the light source part 92 having a constant light distribution angle directly lights an object (for example, the fingerprint) which is brought into contact with the R1 surface. However, since in accordance with an increase in proximity to a center of the fingerprint, a distance from the light source part 92 is increased, lighting by direct light becomes difficult. Therefore, the vicinity of the center of the fingerprint becomes dark, and it is likely that an appropriate fingerprint image cannot be obtained.

Therefore, in the present embodiment, the lens 70 is provided with the wall parts 73A and 73B and the shoulder surface parts 75A and 75B, the illumination light emitted from the light source part 92 is guided so as to repeat reflection of the illumination light inside the lens 70, and the light is thereby caused to reach the center of the fingerprint. Here, it is required for the reflection of the light emitted from the light source part 92 on the surfaces to satisfy total reflection conditions in view of ensuring of illumination intensity. In addition, when the illumination light travels toward the R2 surface, in order to avoid incidence of the illumination light, as stray light, on the concave lens array 71 (specifically, the individual concave lenses 71A) installed on the R2 surface while the total reflection conditions are satisfied as mentioned above, a reflecting surface angle of each of the shoulder surface parts 75A and 75B is set such that an incident angle is a viewing angle or more. On the basis of the above-mentioned viewpoints, lighting conditions are appropriately set.

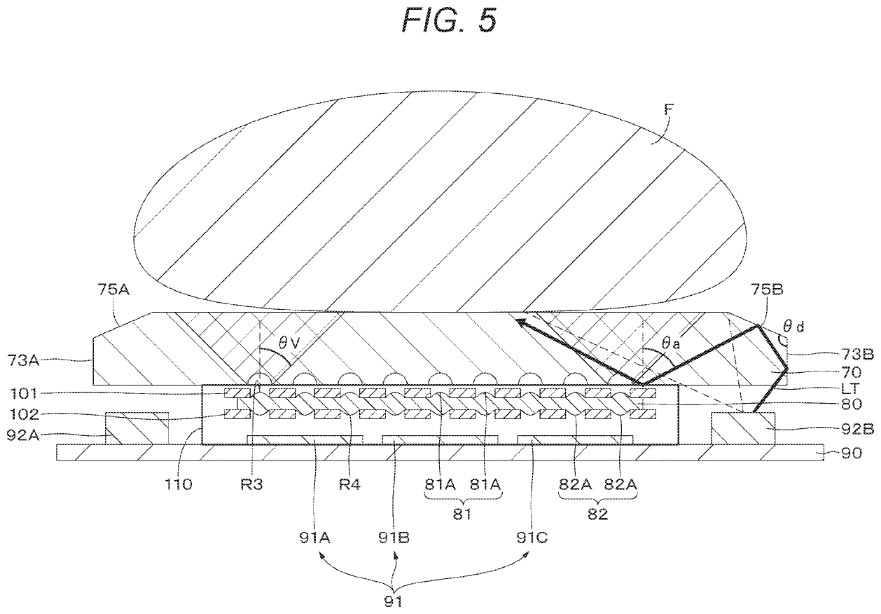

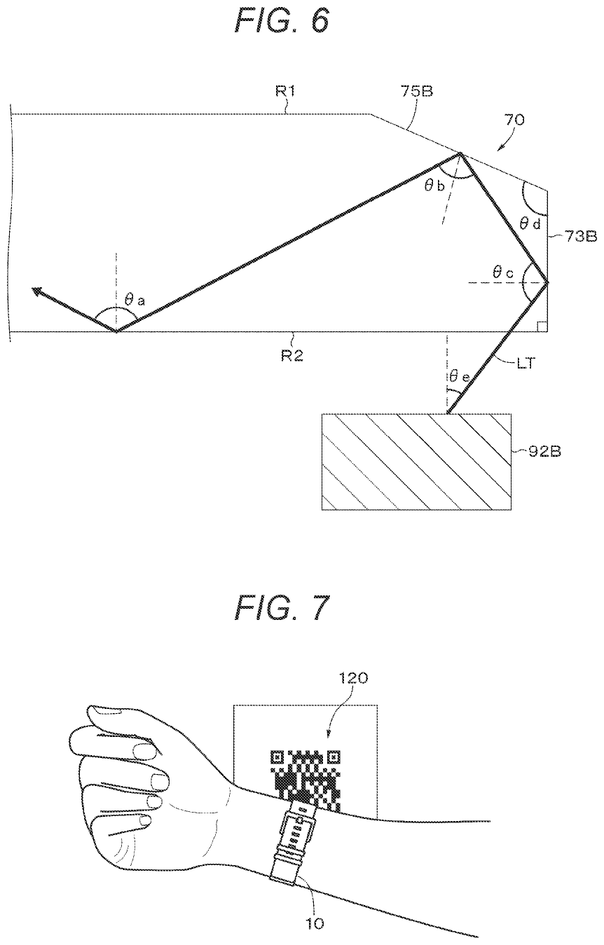

With reference to FIGS. 5 and 6, a specific example of the lighting conditions will be described. Note that a part denoted by a reference sign F in FIG. 5 schematically illustrates a fingertip which is brought into contact with the R1 surface. In addition, FIG. 6 is a diagram showing the vicinity of the wall part 73B and the shoulder surface part 75B of the lens 70 in an enlarged manner. Note that although in the below description, description is given by illustrating the wall part 73B and the shoulder surface part 75B of the lens 70 as an example, for the wall part 73A and the shoulder surface part 75A on a side opposite thereto, lighting conditions are similarly set. In addition, an arrow denoted by LT in FIGS. 5 and 6 schematically illustrates light having high illumination intensity, of the illumination light which is emitted from the LED 92B, is totally reflected on the surfaces, and propagates. In addition, in FIG. 6, a part of the configuration is shown in a simplified manner.

An shown in FIGS. 5 and 6 mean the following angles.

Angle θa: a reflection angle of the illumination light LT on the R2 surface

Angle θb: a reflection angle of the illumination light LT on the shoulder surface part 75B

Angle θc: a reflection angle of the illumination light LT on the wall part 73B (side surface)

Angle θd: an angle (reflecting surface angle) formed between the wall part 73B and the shoulder surface part 75B.

Angle θe: as emission angle of the illumination light LT

Angle θv: a half value (half viewing angle) of a viewing angle of each of the concave lenses 71A

Conditions which should be satisfied to set the reflecting surface angle θd as follows.

Condition 1: angles θa, θb, and θc are set so as to satisfy the total reflection conditions.

Condition 2: Since it is desired that the living body is brought into contact with the whole R1 surface, the reflecting surface angle θd is set to a reflecting surface angle θd>90°.

Condition 3: the angle θa is set to the angle θv or more.

The LED 92A itself has sufficiently wide light distribution characteristics, and light totally reflected on the wall part 73B is present invariably in a fixed proportion. The condition 1, that is, the angles which satisfy the total reflection conditions are obtained from the following Formula 1.

(Formula 1)

Arcsin(1/n1) (1)

Expressed by n1 is a d line refractive index (a refractive index of a d line (a wavelength of 587.6 nm)) of a material (medium) of which the lens 70 is constituted. As a specific example, in a case where the lens 70 is constituted of an optical material of an olefinic resin (a d line refractive index is 1.535),

Arcsin(1/1.535)=40.7°

results, and a total reflection condition is a total reflection condition ≥40.7°.

In addition, although the light source part 92 itself has a sufficient light distribution angle, since a light distribution angle in a further narrow range is further high as luminance due to characteristics, consideration is made, presupposing that an incident angle to the wall part 73B is a further large angle. On the basis of this respect and geometric relationship, a relation of θd=θb+θc holds. When a relation of θb≥40.7° θd>90° is made from the conditions 1 and 2, a relation of θc>49.3° holds.

Next, the conditions 1 and 3 are considered. When θv is set to 64° in this example, since when illumination light incident on the R2 surface is this angle or more, if the illumination light is incident on an imaging optical system, the illumination light is cut by the light shielding body 101, which functions as a diaphragm, or the like, it does not occur that the illumination light reaches the image element 91 as stray light. In addition, when reflection is made with the total reflection conditions satisfied, also on she region AR2, a certain illumination intensity can be ensured. A relation of θd=θa−θb+90° holds from geometric relationship. Here, in light of θa≥64° and θb≥40.7°, θd≥113.3° holds.

Although hereinbefore, the description is made by dividing the description as to the conditions 1 and 2 and the description as to the conditions 1 and 3, when generalization by integration thereof is made, the reflecting surface angle θd is set on the basis of the following Formula 2.

(Formula 2)

θd≥θv+arcsin(1/n1)+90° (2)

### Effects Obtained by Embodiment

According to the present embodiment, for example, effects described below can be obtained.

Since a member such as a light guiding plate which guides the illumination light to a side of the R1 surface can be omitted by a configuration in which an illumination optical system and the imaging optical system are integrated, the whole optical module can be downsized and manufacturing costs can be reduced.

In addition, by decreasing a number of components, variation in assembling the components can be reduced. Thus, deterioration in resolution performance upon imaging can be reduced.

In addition, since illumination intensity distribution on the R1 surface can be uniformized, a captured image having high resolution can be obtained. Thus, accuracy of authentication using the above-mentioned captured image can be enhanced.

By the integration of the configuration of the optical module, eccentricity of each of the lenses can be inhibited and stable optical performance can be obtained.

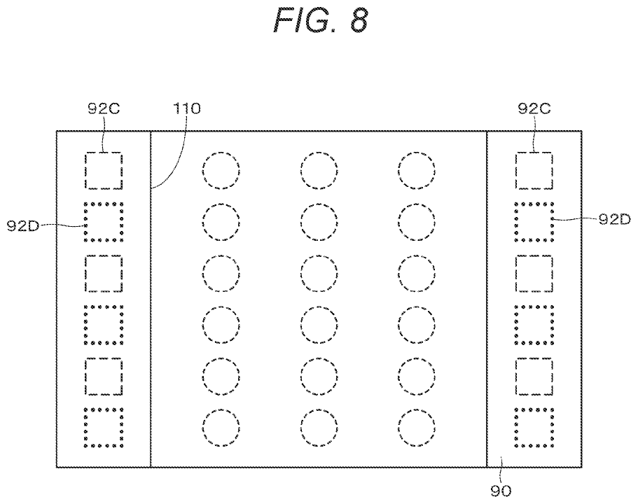

By the configuration having the concave lens array and the convex lens arrays on both surfaces, a wide angle is enabled, and a short focus is enabled while comparatively high resolving power is retained. In addition, since defocusing due to variation in a distance up to an imaged target can be comparatively inhibited, it is made possible to cope with imaging of a code pattern such as a QR code (registered trademark), which is located at a certain distance (for example, a distance of approximately 10 cm to 20 cm), besides imaging of the living body by contacting. For example, as illustrated in FIG. 7, the display of the wristband type electronic device 10 is faced toward a code pattern 120 displayed on a screen, and the code pattern 120 can be thereby imaged. Then, settlement processing or the like in accordance with the code pattern 120 can be performed. As described above, a code pattern which is present in a position facing the R1 surface may be imaged by the image element which the optical module has.

### EMBODIMENTS

Subsequently, embodiments of the present disclosure will be described. Note that the present disclosure is not limited to the below-described embodiments. In addition, in each of the below-described embodiments, an optical module has a structure similar to the above-described structure and a reflecting surface angle θd satisfies the above-described conditions. However, in an embodiment 2, an optical module is configured to have a single (one) image element.

### Embodiment 1

In an embodiment 1, an example in which an optical module is provided on a side surface of a main body (housing) of a smartphone, a smartwatch, or the like is assumed. An imaging range for one image element with a living body contacting an R1 surface is set to 2 mm×6 mm, and a handling distance (a distance up to a code pattern) upon imaging a code pattern is set within 50 mm. The image element is a 1/10.5-type sensor, and as similar to the embodiment, three image elements are provided in such a way as to be arrayed in a longer side direction of a substrate. In consideration of supposed setting positions, as the image elements, small-sized sensors are used.

As to each of one of concave lenses constituting a concave lens array and one of convex lenses constituting a convex lens array, parameters of a curvature, a surface interval, glass material information (a refractive index and an Abbe number), and each lens focal distance are shown in Table 1. Note that in Table 1, L1 means a lens 70, R1 shows an R1 surface (flat surface), and R2 shows concave lenses 71A formed on an R2 surface. In addition, in Table 1, L2 means a lens 80, R3 shows convex lenses 81A provided on an R3 surface, and R4 shows convex lenses 62A provided on an R4 surface. A surface of each of the individual lenses is an aspheric surface formed by resin molding, thus allowing a high-resolution image to be captured over the whole imaging range. In addition, in Table 1, an aperture diaphragm means a diaphragm by a light shielding body 101. Note that because the R1 surface is the flat surface, a curvature radius is shown as “INFINITY”. Those described above in Table 1 are similarly applied in other Tables.

TABLE 1
Lens basic parameters

| | | | Surface | Refractive | Abbe | Each lens focal |
|---|---|---|---|---|---|---|
| | | Curvature | interval | index | number | distance |
| L1 | R1 | INF | 1 | 1.535037 | 55.7098 | −0.225 mm |
| | R2 | 0.12127 | 0.137 | | | |
| Aperture | | | 0.05 | | | |
| diaphragm | | | | | | |
| L2 | R3 | 0.298 | 0.3 | 1.66134 | 20.3725 | 0.244 mm |
| | R4 | −0.21749 | 0.3768 | | | |

In Table 2, aspheric coefficients of the lenses are shown.

TABLE 2
Aspheric coefficients

| | | Conic | Tertiary | Quartic | Quintic | Sextic |
|---|---|---|---|---|---|---|
| | | coefficient | coefficient | coefficient | coefficient | coefficient |
| L1 | R1 | | | | | |
| | R2 | −0.3 | 0.4 | −18.6 | 210.2 | −2500.0 |
| L2 | R3 | −9.1 | 5.8 | −214.9 | 4400.0 | −30030.0 |
| | R4 | −4.8 | 0.3 | −50.0 | 187.0 | 609.0 |

In Table 3, a pitch between concave lenses 71A and a number thereof (which may be a pitch between convex lenses 81A and a number thereof or may be a pitch between convex lenses 82A and a number thereof) are shown.

TABLE 3
Lens array configuration

| Lens pitch | | | 0.47 mm |
|---|---|---|---|
| | Number of lenses | Longer side | 9 |
| | | direction | |
| | | Shorter side | 2 |
| | | direction | |

In Table 4, a focal distance of the whole system of an optical module, an effective F number, an aperture diameter, and an overall optical length (a distance from the image elements up to the R1 surface) are shown.

TABLE 4
Lens data

| Focal distance | 0.181 | mm |
|---|---|---|
| Effective F number | 3.6 | |
| Aperture diameter | ϕ0.1 | mm |
| Overall optical length | 1.864 | mm |

In Table 5, an imaging range, an image size, a magnification, and the whole view angle (20v) of a single lens group in a case where imaging is performed by bringing a living body (a fingerprint in the present embodiment) into contact with the R1 surface are shown. Note that the single lens group means a lens group single body which includes lenses mutually arranged on the same axis (one unit functioning as a wide-angle lens). The single lens group in the present embodiment is constituted of one concave lens 71A, one convex lens 81A, and one convex lens 81B. A single lens group described in each of other Tables (Table 6, Table 11, and Table 12) is similar thereto.

TABLE 5
Case where living body is brought
into contact with L1 and R1 surface

| Imaging range of single lens group | ϕ1.650 |
|---|---|
| Image size of single lens group | ϕ0.415 |
| Magnification | 0.2516 |
| Whole view angle | 125 |

In Table 6, an imaging range, an image size, a magnification, and the whole view angle (20v) of the single lens group in a case where ac object located in a place 50 mm away from the R1 surface is imaged are shown.

TABLE 6
L1 and R1 surface to object surface: 50 mm

| Imaging range of single lens group | ϕ195 |
|---|---|
| Image size of single lens group | ϕ0.415 |
| Magnification | 0.0021 |
| Whole view angle (diagonal direction) | 125 |

The embodiment 1 was evaluated on the basis of the above-described parameters by using a modulation transfer function (MTF). In the case where imaging was performed by bringing the living body into contact with the R1 surface, it was confirmed that an image side space frequency over the most peripheral part from a center of an imaging region of the single lens group was 50 line pairs (LP)/mm and an image had sufficient contrast. Thus, it was confirmed that for example, even in the case where the fingerprint was imaged, as to a minute structure like a sweat gland, not ridges, it was made possible to acquire a resolvable image.

In addition, although for a code pattern located at a distance of approximately 50 mm of an object distance, defocusing due to variation in the object distance occurred, it was confirmed that an amount of the defocusing was suppressed because of a comparatively short focal distance and even with the space frequency of 50 LP/mm, a constant contrast was obtained.

### Embodiment 2

In an embodiment 2, an example in which an optical module is provided on a top surface (installation surface of a display device) of a main body (housing) of a smartphone, a smartwatch, or the like is assumed. An imaging range of an image element upon bringing' a living body into contact with an R1 surface is set to 5.2 mm×4 mm and a handling distance (a distance up to a code pattern) upon imaging a code pattern is set within 150 mm, The image element is a 1/2.6 type sensor (one). As the image element, in consideration of an assumed setting position, a large-sized image element is used.

As to each of one of concave lenses constituting a concave lens array and one of convex lenses constituting a convex lens array, parameters of a curvature, a surface interval, glass material information (a refractive index and an Abbe number), and each lens focal distance are shown in Table 7.

TABLE 7
Lens basic parameters

| | | | Surface | Refractive | Abbe | Each lens focal |
|---|---|---|---|---|---|---|
| | | Curvature | interval | index | number | distance |
| L1 | R1 | INF | 0.5 | 1.535037 | 55.7058 | −0.243 mm |
| | R2 | 0.1303 | 0.207 | | | |
| Aperture | | | 0.05 | | | |
| diaphragm | | | | | | |
| L2 | R3 | 0.311073 | 0.3 | 1.66134 | 20.3725 | 0.333 mm |
| | R4 | −0.4938 | 0.96 | | | |

In Table 8, aspheric coefficients of the lenses are shown.

TABLE 8
Aspheric Coefficients

| | | Conic | Quartic | Sextic |
|---|---|---|---|---|
| | | Coefficient | Coefficient | Coefficient |
| L1 | R1 | | | |
| | R2 | −1.013580 | 22.050 | 1268.400 |
| L2 | R3 | 1.7614160 | −3.324270 | −224.520 |
| | R4 | −10.0 | 1.31520 | 452.800 |

In Table 9, a pitch between concave lenses 71A and a number thereof (which may be a pitch between convex lenses 81A and a number thereof or may be a pitch between convex lenses 82A and a number thereof) are shown.

TABLE 9
Lens array configuration

| Lens pitch | | | 0.4 mm |
|---|---|---|---|
| | Number of lenses | Longer side | 13 |
| | | direction | |
| | | Shorter side | 10 |
| | | direction | |

In Table 10, a focal distance of the whole system of an optical module, an effective F number, an aperture diameter, and an overall optical length (a distance from the image elements up to the R1 surface) are shown.

TABLE 10
Lens data

| Focal distance | 0.326 | mm |
|---|---|---|
| Effective F number | 4.97 | |
| Aperture diameter | ϕ0.2 | mm |
| Overall optical length | 2.017 | mm |

In Table 11, an imaging range, an image size, a magnification, and the whole view angle (20v) of a single lens group in a case where imaging is performed by bringing a living body (a fingerprint in the present embodiment) into contact with the R1 surface are shown.

TABLE 11
Case where living body is brought
into contact with L1 and R1 surface

| Imaging range of single lens group | ϕ0.6 |
|---|---|
| Image size of single lens group | ϕ0.554 |
| Magnification | 0.981 |
| Whole view angle | 70 |

In Table 12, an imaging range, an image size, a magnification, and the whole view angle (20v) of a single lens group in a case where an object located in a place 150 mm away from the R1 surface is imaged are shown.

TABLE 12
L1 and R1 surface to object surface: 150 mm

| Imaging range of single lens group | ϕ212 |
|---|---|
| Image size of single lens group | ϕ0.554 |
| Magnification | 0.0026 |
| Whole view angle (diagonal direction) | 70 |

The embodiment 2 was evaluated on the basis of the above-described parameters by using an MTF. In the case where imaging was performed by bringing the living body into contact with the R1 surface of the lens 70, it was confirmed that an image side space frequency over the most peripheral part from a center of an imaging region of the single lens group was 50 LP/mm and an image had sufficient contrast. Thus, it was confirmed that for example, even in the case where the fingerprint was imaged, as to a minute structure like a sweat gland, not ridges, it was made possible to acquire a resolvable image.

In optical design in the embodiment 2, a focal distance was approximately 1.8 times as long as the focal distance in the embodiment 1. Since the focal distance is long, a defocusing amount with respect to variation in a distance up to an object increases. Therefore, a resolution on the sensor surface (image element) with the object distance being 150 mm decreases. However, as a result of evaluating the MTF, it was confirmed that low frequency information of approximately 10 Lp/mm was retained. Even when the retained information is the low frequency information, pattern recognition of the code pattern is enabled by deconvolution with respect to images of the individual lenses and a restoration processing technology by machine learning using a plurality of pieces of image information. Accordingly, even with the optical design as in the embodiment 2 and the configuration in which the single image element was used, it was confirmed that the recognition of the living body information and the code pattern was enabled.

### MODIFIED EXAMPLES

Although hereinbefore, the embodiments of the present disclosure are specifically described, contents of the present disclosure are not limited to the above-described embodiments and a variety of modifications based on technical ideas of the present disclosure can be made. Hereinafter, modified example will be described.

It may be made possible to acquire different pieces of living body information by an optical module 100. For example, as shown in FIG. 8, light sources 92C and 92D whose wavelengths are different from each other may be provided on a substrate 90. The light sources 92C are, for example, visible light sources and the light sources 921 are infrared light sources. As shown in FIG. 8, the light sources 922 and 92D are alternately arranged. In addition, the light sources facing each other are the same kinds of light sources. Three kinds or more of light sources may be provided on the substrate 90.

Specific examples of the light sources 92C and 92D and specific examples of preferred imaged targets will be described.

Example 1: Light sources which emit near-infrared light whose wavelength is approximately 940 nm. Imaged targets are a vein, a melanin, a subcutaneous fat thickness, and the like.

Example 2: Light sources which emit infrared light whose wavelength is approximately 660 nm. Imaged targets are skin characteristics (transparency), an artery (pulse), a melanin, and the like.

Example 3: Light sources which emit green light whose wavelength is approximately 570 nm. Imaged targets are a fingerprint and an artery (pulse).

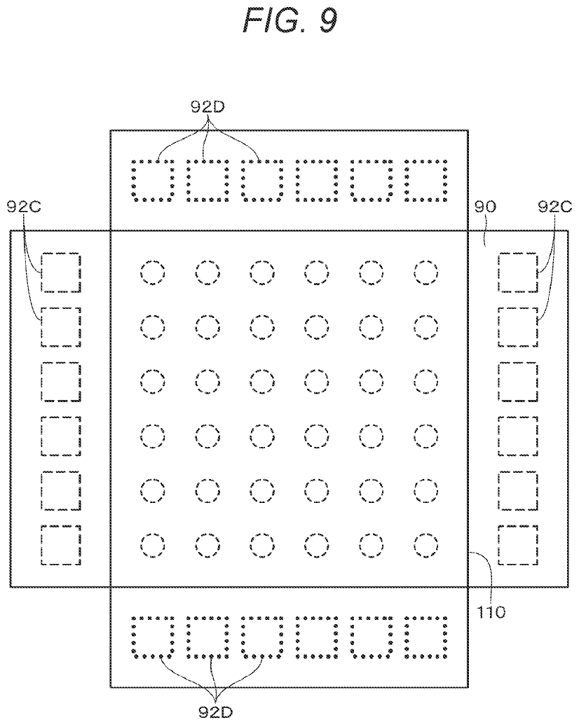

In addition, as shown in FIG. 9, light sources whose wavelengths are different from each other may be provided over a perimeter all around a periphery of a frame 110. A state of arrangement of the light source part 92 can be appropriately changed. In addition, the light source part 92 may be lasers or the like, instead of the LEDs.

In addition, when the optical module according to the embodiment is manufactured, a predetermined jig may be used. Since by using the jig, accurate positioning of the concave lens array and the convex lens arrays is enabled, deterioration in resolution performance due to relative eccentricity between the concave lens array and the convex lens arrays can be inhibited.

The image element 91 and the light source part 92 may be mounted on substrates which are different from each other. A shape of the frame 110 can be appropriately changed, and no frame 110 may be present.

The configurations, methods, processes, shapes, materials, values, and the like cited in the above-described embodiments and modified examples are merely illustrative, configurations, methods, processes, shapes, materials, values, and the like which are different from those cited therein may be used as needed, and the configurations, methods, processes, shapes, materials, values, and the like cited therein can also be replaced with the heretofore known ones. In addition, the configurations, methods, processes, shapes, materials, values, and the like cited in the above-described embodiments and modified examples can be mutually combined in a range in which no technical inconsistency is caused. In addition, the present disclosure can be realized by any form such as a control method and an apparatus for manufacturing an electronic device.

Note that contents of the present disclosure are not construed in a limited manner by effects illustrated in the present description.

The present disclosure can also have the following configurations.

(1)

An optical module including:

a first lens having a first principal surface and a second principal surface; and

a second lens having a third principal surface and a fourth principal surface, in which

the first principal surface is configured by a flat surface and on the second principal surface, a concave lens array having a plurality of concave lenses is formed.

on each of the third principal surface and the fourth principal surface, a convex lens array having a plurality of convex lenses is formed, and

the second principal surface and the third principal surface are arranged in such a way as to face each other.

(2)

The optical module according to (1), in which shoulder surface parts are formed in portions connecting the first principal surface and the second principal surface, the shoulder surface parts being formed so as to cause illumination light being emitted from a predetermined light source part not to enter the concave lens array.

(3)

The optical module according to (2), in which

in a case where an angle being formed between a direction perpendicular to an end portion of the second principal surface and each of the shoulder surface parts is defined as a reflecting surface angle θd, the reflecting surface angle θd is set so as to cause the illumination light being emitted from the predetermined light sources not to enter the concave lens array.

(4)

The optical module according to (3), in which the reflecting surface angle is set by Formula (1) described below.

θd>θv+arcsin(1/n1)+90° (1)

where θv represents a half value of a viewing angle of each of the concave lenses and n1 represents a d line refractive index of a material by which the first lens is configured.

The optical module according to any one of (1) to (4), in which

in a case where a focal distance of each of the individual concave lenses by which the concave lens array is configured is defined as f1 and a focal distance of each of the individual convex lenses by which. the convex lens array is configured is defined as f2, relations (2) and (3) described below hold.

−0.3<f1<−0.2 (2)

0.1<f2<0.35 (3)

(6)

The optical module according to any one of (2) to (5), in which

the illumination light is guided by the first lens.

(7)

The optical module according to any one of (2) to (5), further including

an image element being disposed in such a way as to face the fourth principal surface.

(8)

The optical module according to (7), in which the light source part is mounted on a surface which is same as a surface of a substrate, on which the image element is mounted.

(9)

The optical module according to (8), in which

on a side of the third principal surface of the second lens, a first light shielding body is provided, and on a side of the fourth principal surface of the second lens, a second light shielding body is provided.

(10)

The optical module according to (9), further including

a frame which supports the second lens, the first light shielding body, and the second light shielding body and houses the second lens, the first light shielding body, and the second light shielding body inside the frame.

(11)

The optical module according to (10), in which the frame and the first lens are bonded.

(12)

The optical module according to any one of (1) to (11), in which

a living body being brought into contact with the first principal surface is imaged by the image element.

(13)

The optical module according to any one of (1) to (12), in which

a code which is present in a position facing the first principal surface is imaged by the image element.

(14)

An authentication device including the optical module according to any one of (1) to (13).

### REFERENCE SIGNS LIST

10 Wristband type electronic device
70 First lens
71 Concave lens array
71A Concave lens
73A, 73B Wall part
75A, 75B Shoulder surface part
80 Second lens
81, 82 Concave lens array
81A, 82A Concave lens
90 Substrate
91, 91A, 91B, 91C Image element
92 Light source part
92A, 92B LED
100 Optical module
101 First light shielding body
102 Second light shielding body
110 Frame
R1 surface First principal surface
R2 surface Second principal surface
R3 surface Third principal surface
R4 surface Fourth principal surface

1. An optical module comprising:
a first lens having a first principal surface and a second principal surface; and
a second lens having a third principal surface and a fourth principal surface, wherein
the first principal surface is configured by a flat surface and on the second principal surface, a concave lens array having a plurality of concave lenses is formed,
on each of the third principal surface and the fourth principal surface, a convex lens array having a plurality of convex lenses is formed, and
the second principal surface and the third principal surface are arranged in such a way as to face each other.

2. The optical module according to claim 1, wherein
shoulder surface parts are formed in portions connecting the first principal surface and the second principal surface, the shoulder surface parts being formed so as to cause illumination light being emitted from a predetermined light source part not to enter the concave lens array.

3. The optical module according to claim 2, wherein
in a case where an angle being formed between a direction perpendicular to an end portion of the second principal surface and each of the shoulder surface parts is defined as a reflecting surface angle θd, the reflecting surface angle θd is set so as to cause the illumination. light being emitted from the predetermined light sources not to enter the concave lens array.

4. The optical module according to claim 3, wherein
the reflecting surface angle is set by Formula (1) described below,
θd≥θv+arcsin(1/n1)+90° (1)
where θv represents a half value of a viewing angle of each of the concave lenses and n1 represents a d line refractive index of a material by which the first lens is configured.

5. The optical module according to claim 1, wherein
in a case where a focal distance of each of the individual concave lenses by which the concave lens array is configured is defined as f1 and a focal distance of each of the individual convex lenses by which the convex lens array is configured is defined as f2, relations (2) and (3) described below hold.
−0.3<f1<−0.2 (2)
0.1<f2<0.35 (3)

6. The optical module according to claim 2, wherein the illumination light is guided by the first lens.

7. The optical module according to claim 2, further comprising
an image element being disposed in such a way as to face the fourth principal surface.

8. The optical module according to claim 7, wherein
the light source part is mounted on a surface which is same as a surface of a substrate, on which the image element is mounted.

9. The optical module according to claim 8, wherein
on a side of the third principal surface of the second lens, a first light shielding body is provided, and on a side of the fourth principal surface of the second lens, a second light shielding body is provided.

10. The optical module according to claim 9, further comprising
a frame which supports the second lens, the first light shielding body, and the second light shielding body and houses the second lens, the first light shielding body, and the second light shielding body inside the frame.

11. The optical module according to claim 10, wherein
the frame and the first lens are bonded.

12. The optical module according to claim 1, wherein
a living body being brought into contact with the first principal surface is imaged by the image element.

13. The optical module according to claim 1, wherein
a code which is present in a position facing the first principal surface is imaged by the image element.

14. An authentication device comprising the optical module according to claim 1.
